(19) United States
(12) Patent Application Publication
(10) Pub. No.: US 2021/0239188 A1
(43) Pub. Date: Aug. 5, 2021

(54) DUAL MASS DOG COLLAR AND/OR DUAL MASS DOG HUB FOR A POWER TRANSMISSION SYSTEM

(71) Applicant: Leonidas Kyros Kontopoulos, Frankfurt am Main (DE)

(72) Inventors: Konstantinos Kontopoulos, Frankfurt am Main (DE); Grigorios Maximilian Kontopoulos, Frankfurt am Main (DE)

(73) Assignees: Kyros Philippos Kontopoulos, Frankfurt am Main (DE); Leonidas Kyros Kontopoulos, Frankfurt am Main (DE)

(21) Appl. No.: 16/779,024

(22) Filed: Jan. 31, 2020

(51) Int. Cl. F16H 3/089; F16H 61/684; F16D 11/14; B60K 17/08; B60K 17/02; B63H 23/30

(52) U.S. Cl. CPC F16H 3/089; F16H 61/684; F16D 11/14; B60K 17/08; F16H 2708/12; B63H 23/30; F16H 2200/0034; F16H 2306/50; F16H 2306/46; B60K 17/02

(57) ABSTRACT

The present application relates to a dual mass dog collar 1 of a dog clutch, to a dual mass dog hub 3 of a dog clutch, to a power transmission system (gearbox) 2 and to a method to operate said power transmission system, comprising at least one dual mass dog collar 1 and/or at least one dual mass dog hub 3.

The present application relates to the field of power transmission systems and in particular to a dog clutch, for a power transmission system, to a power transmission system, to a method to operate said power transmission system and to an engine comprising said dual mass dog clutch.

Power transmission systems (i.e. gearboxes) are adapted by known automotive vehicles, such as trucks, cars, motorbikes or the like, in order to provide a range of speed and torque outputs, which are necessary during the movement of the vehicle.

Power transmission systems (i.e. gearboxes) are also used in inboard/outboard motors or inboard motors of marine engines in order to change from forward to reverse gear.

Most manual power transmission systems adapted in automotive vehicles or marine engines comprise a dog clutch. The dog clutch comprises a dog hub and a dog collar or a dog collar assigned directly on a shaft. Dog clutches are used inside the manual transmission in order to lock different gears to the rotating input and output shafts.

Gear wheels rotate constantly and therefore high wear and tear forces act on the gearbox components while shifting from one gear ratio to another. Such forces are commonly limited by using synchronizing mechanism that match the speed of the components being engaged. When a synchronizing mechanism is not used, in order to allow a smoother shifting, elastic elements are adopted, in order to absorb the impact on the components during shifting processes.

With the present innovation, which presents a dual mass dog collar of a dog clutch and/or a dual mass dog hub of a dog clutch, the demanded time for a gear changing action is minimized, torque peaks and unwanted noises can be reduced the lifetime of the transmission system is increased and a continuously power transfer can achieved.

In addition the proposed dual mass dog collar of a dog clutch and/or a dual mass dog hub of a dog clutch can be adapted in both manual and automatic power transmission systems.

The presented dual mass dog collar (sleeve) is torque proof engaged with a dog hub being torque proof engaged with a shaft, or is being directly torque proof engaged with the shaft.

The dual mass dog collar (sleeve) is consisted by an inner part, being torque proof engaged with the assigned dog hub or with the assigned shaft and an outer part, being engageable with a free, engageable gear wheel. A free, engageable gear wheel is a gear wheel that is selectively engaged by the dual mass dog collar to the assigned shaft, free to rotate when not engaged, transferring torque to the assigned shaft only upon engagement.

The inner part and the outer part have a common rotational axis and are arranged concentrically to the assigned shaft. Further, the inner part is at least partially arranged within the outer part and the inner part is coupled to the outer part by means of two elastic elements (a first and a second elastic element) with different spring constants arranged in a parallel configuration, so that the inner part is arranged angularly deflectable with respect to the outer part around the common rotational axis.

The elastic elements can be spring elements, such a torque springs or a spiral springs, torsional springs, or any other elastic elements such as rubber blocks etc. Further, different types of elastic elements can be combined in a dual mass dog collar in order to achieve a desired spring characteristic

The two elastic elements may be positioned within one spring compartment, formed by the inner part and the outer part of the dual mass dog collar. Alternatively the elastic elements can be positioned in separate compartments but in any case the two elastic elements will be positioned in an arrangement that the first elastic element, having a smaller (in relation to the second elastic element) spring constant, is initially deformed upon deflection of either the inner or the outer part of the dual mass dog collar (providing the required time in order to achieve a complete engagement before the second spring element begins to bear load), and the deformation of the second elastic element (having a greater spring constant in relation to the first spring element) follows as the deflection progresses. In particular, the spring compartment can be a closed compartment. Alternatively, the spring compartment may be an open compartment that allows heat exchange and a facilitated maintenance of the springs.

Both inner outer part are axially movable together with the help of shifting fork on the assigned dog hub or shaft.

The outer part comprises engagement means. The engagement between outer part of the dual mass dog collar (sleeve) and the free, engageable gear wheel is temporally and is achieved with the help of engagement means (e.g. teeth) that are adapted to engage with the engagement means of the free, engageable gear wheel. Accordingly the outer part can transfer rotational force and/or torque to the inner part via the at least two elastic elements. Due to the fact that the inner part is torque proof engaged with the shaft rotational forces and/or torque can be transferred from the free, engageable gear wheel to the shaft and vice versa.

For example two elastic elements may be provided with the first elastic element being longer than the second elastic element, in constant contact with both the inner and the outer part of the dual mass dog collar and the second elastic element will be in contact after the deflection of one of the inner or outer parts, since it is shorter in relation to the first elastic element. The terms shorter and longer, describing the elastic elements consisting the set of two elastic elements, are a reference in the length of the elastic elements when the elements are not loaded by the deflection of one of the inner and outer parts (Neutral position). Therefore the reference length is the installed length of the first spring element and the free length of the other elastic element, when the dual mass dog collar (sleeve) is not engaged with the assigned free, engageable gear wheel. Furthermore the inner and the outer part of the dual mass dog collar are adapted to rotate with the same angular velocity if the set of two elastic elements is fully loaded under the occurring load.

Particularly, a first spring element may be partially arranged within a second spring element and may protrude out of the second spring element on a front face, wherein the spring constant of the first spring element will be lower than the spring constant of the second spring element. The exemplary set of spring elements will comprise one spring element having a bigger diameter concentrically placed to a spring element having a smaller diameter. As mentioned above in an alternative configuration each elastic element consisting the two elastic elements can be positioned in different compartments but always the softer spring element will be in constant contact with both the inner and the outer parts of the dual mass dog collar and will be deformed initially, with the deformation of the second elastic element (stiffer) following, after the progression of the deflection of the components and the deformation of the first spring element. As it is obvious the deformation of the second elastic element will be accompanied by the continuing deformation of the first spring element. The first (longer, softer) spring element is additionally adopted in order not to allow the relative motion between the inner/outer part of the dual mass dog collar (sleeve) when the outer part is not engaged with an assigned free, engageable gear wheel, no matter if the inner or outer part accelerates, decelerates or both rotate with the same angular velocity (neutral position).

For example when as a first elastic element a torsional spring is used, the first (softer, longer) spring is preloaded so that:

Tₚᵣₑ≥J*ωₘₐₓ

Where Tₚᵣₑ is the preloaded torque of the spring, J is the moment of inertia of the outer part of the dual mass dog collar and ωₘₐₓ is the maximum angular acceleration/deceleration that can be achieved by the assigned shaft. The first preloaded spring is adapted in order to have negligible deformation when the dual mass dog collar is not engaged with a free, engageable gear wheel, regardless if the inner/outer part of the dual mass dog collar (or assigned shaft) accelerate, decelerate or rotate with a constant angular velocity. As a result when the dual mass dog collar is not engaged with the free, engageable gear wheel, stays in a neutral position with the softer spring element being negligibly deformed, despite any occurring acceleration or deceleration of the assigned shaft which is torque proof engaged with the dual mass dog collar (either directly via the inner part or via a dog hub), due to the existence of the preloaded first softer spring. Alternatively as a person skilled in the art understands, the so called neutral position can occur without the softer spring being preloaded, but in that case a higher spring constant (k) in comparison to the spring constant of the preloaded spring has to be adopted.

The second spring element may be shorter than the first spring element and it may starts to be compressed after the progression of deflection of the inner/outer part of the dual mass dog collar and the completion of the engagement of the engaging components (i.e. dual mass dog collar and free, engageable gear wheel). The second spring element is the one that transfers rotational forces and/or torque, handling the occurring load. It is obvious that the first, softer spring element also transfers some rotational force and/or torque but due to the fact that the spring constant, in relation to the spring constant of the second elastic element, is very small (<<k) the rotational forces and/or torque being transferred via the softer spring element are insignificant, despite the deformation of the first elastic element. The spring constant (k) of the second (stiffer) elastic element is in relation to the maximum torque provided by the engine.

As a person skilled in the art understands, due to the fact that the moment of inertia of the outer part of the dual mass dog collar is very small, a significantly small spring constant (k) and Tₚᵣₑ is demanded, and therefore a smooth effortless engagement between the engaging components (i.e. dual mass dog collar and free, engageable gear wheel) can be achieved, without damaging the engagement means (e.g. teeth).

As it is apparent, the existence of the softer spring element contributes to a smooth engagement, and the existence of the stiffer spring element contributes to the power transfer after the completion of the engagement.

The existence of a least two elastic elements adapted in a parallel positioning, with the first spring element with a smaller spring constant being initially deformed upon deflection and the deformation of the second elastic element with the greater spring constant in relation to the spring constant of the first elastic element following, is a key feature of the proposed innovation since the role of the two elements is different. The initially deformed element contributes to a smoother engagement and provides the necessary time for the completion of engagement, and the second elastic element is the one that the transfers the torque according to the occurring load.

As it is well known, every elastic element has a certain deformation limit. When this limit is surpassed, the element loses its elastic characteristics and therefore it is no longer functional.

This is the difference in relation to other patent documents having elastic elements in a series configuration.

In my proposal the parallel positioning of the elastic elements having different spring constants allows loading the first spring element firstly and independently (in its initial deformation) in relation to the second elastic element which deforms after the progression of the deflection and its deformation is accompanied by a continuance in the deformation of the first spring element.

As a person skilled in the art understands, since the engagement of my proposal takes place between the free, engageable gear wheel and the outer part of the dual mass dog collar (sleeve), (which has small inertia and is the one that engages with the free, engageable gear wheel), and since the resistance of the soft spring is very small, a quick and smooth engagement can be achieved.

In case where conventional dog collars were used, the inertia would be the inertia of the entire system. In addition, in case where elastic elements were used in a series configuration the difference in the spring constants of the elastic elements had to be great. It is worth mentioning that, great differences in spring constants are not permitted, since the applied force is the same for every elastic element adopted in a series configuration and the danger of plastic deformation of one elastic element is present.

Therefore, the only way to surpass this drawbacks is by adopting two elastic elements having different spring rates (for example one longer and one shorter) in parallel configuration, as presented in my proposal (the ratio between the demanding spring resistance of the first spring element to the maximum applied force for handling the maximum load is about 1/1000).

It is going without saying that more than two elastic elements can be adopted with each of the additional elastic elements behaving in a similar manner as the described two elastic elements, with respect to the role of each of the described elements.

The objects are further at least partly achieved by a proposed power transmission system, e.g. for an automotive vehicle, that comprises at least one input shaft, supporting input gear wheels and an output shaft, supporting output gear wheels (an input gear wheel is a gear wheel assigned to the input shaft and an output gear wheel is a gear wheel assigned to the output shaft).

Either input gear wheels or output gear wheels can be free, engageable gear wheels. Each of the input gear wheels constantly meshes with a corresponding output gear wheel, thereby defining a gear ratio. The power transmission system further comprises at least one dual mass dog collar (sleeve) that is assigned to the input shaft or the output shaft and to one free to rotate, engageable gear wheel. The dual mass dog collar (sleeve) is arranged axially movable along the assigned shaft to change a gear ratio, wherein the engagement means of the outer part of the dual mass dog collar (sleeve) are adapted to engage with the engagement means of the assigned free, engageable gear wheel, thereby torque proof fixing the assigned free, engageable gear wheel with the shaft.

A gear ratio is formed by two gear wheels, wherein a first gear wheel can be a fixed gear wheel, i.e. permanently engaged with a shaft, and a second gear wheel is a free, engageable gear wheel, i.e. adapted to be temporarily engaged with a shaft with the help of a dual mass dog collar. Either of the first or second gear wheels can be an input gear wheel or an output gear wheel. Further, at least one dual mass dog collar (sleeve) is assigned on the respective shaft and between the free, engageable gear wheels. As the outer part of the dual mass dog collar (sleeve) is deflectable with respect to the inner part of the dual mass dog collar (sleeve), and as the inner part is coupled to the outer part by means of two elastic elements, differences in angular velocity during a gear ratio changing action can be compensated and torque can be transferred to assigned shaft.

The input shaft can be powered by an engine and the output shaft can power the wheels of an automotive vehicle. By engaging the dual mass dog collar with an assigned free, engageable gear wheel, the outer part of the dual mass dog collar (sleeve) is torque proof engaged with the assigned free, engageable gear wheel. By this engagement of the dual mass dog collar (sleeve) with the assigned free, engageable gear wheel, power transfer can be achieved from the outer part through the elastic elements to the inner part of the dual mass dog collar which is torque proof engaged with the shaft. Accordingly, by engaging and disengaging different dual mass dog collars, different gear ratios can be chosen.

In a manual transmission system, the gear changing action can be achieved with a simultaneously power cut before shifting or with the contribution of a clutch disk.

When a gear ratio is selected, the input gear wheel transfers rotational force and/or torque to the output free engageable gear wheel that is meshed with. Following, the free gear wheel to the outer part of the dual mass dog collar, which is coupled to the inner part by means of elastic elements. As a consequence these spring elements are being compressed, transferring the rotational force and/or torque through the elastic elements from the outer part to the inner part. Since the inner part of the dual mass dog collar is torque proof engaged with the assigned shaft, power is transferred from the engine to the wheels.

When a gear changing action is commanded, a simultaneous command for a power cut is given, and the second elastic element decompresses (the clutch also disconnects at the same time if needed, for example when power is driven from the wheels to the engine there is no need for clutch disengagement). Dog collar is axially moved and the disengagement can take place.

An axial movement of a dual mass dog collar assigned to the next gear ratio, takes place and the engagement means of that dual mass dog collar engage with the engagement means of the free, engageable gear wheel of the next gear ratio.

As a consequence, softer spring(s) inside the dual mass dog collar assigned to the following gear ratio starts to compress. The engagement has been completed up till the deflection of the outer part of the dual mass dog collar, reaches the second stiffer elastic element.

The second stiffer elastic element compresses in relation to the occurring load and power is transferred to the output shaft via the following gear ratio.

In an alternative either the dog hub or the shaft can house two independently moving dual mass dog collars, with each dual mass dog collar comprising engagement means, on a single face, assigned to a single free, engageable gear wheel.

In an automatic power transmission system the operation of changing gear ratios can be achieved without the help of clutch disk.

In this alternative in an initial stage, the automatic power transmission system can operate with a first gear ratio selected, with the help of a clutch. Apart from the initial stage where a clutch is needed, all the other gear ratio changing actions take place with an absence of a clutch engagement/disengagement but in this case a power cut is demanded.

Accordingly, power is transferred from the input shaft to the output shaft by means of a first pair of gear wheels that define the first gear ratio. A second gear ratio can be defined by a second pair of gear wheels etc.

The free, engageable gear wheel of the first gear ratio transfers the rotational force and/or torque to the outer part of the dual mass dog collar.

Spring elements connecting the outer part and the inner part are being compressed, transferring the rotational force and/or torque to the inner part of the dual mass dog collar.

Since the inner part of the dual mass dog collar is torque proof engaged with the shaft, power is transferred from the engine to the wheels.

The dual mass dog collar, by which the free, engageable gear wheel of the second gear ratio will be engaged with, rotates with an angular velocity (the same as the velocity of the assigned shaft since it is directly torque proof engaged with the assigned shaft or via the dog hub) that is different from the angular velocity of the free, engageable gear wheel that is going to be engaged.

A Central Processing Unit (CPU) with the help of according sensors checks the position of the engagement component(s) and takes account of engines rotations per minute (rpm), engine speed, selected gear ratio, wheel speed etc., and commands a power cut before commanding the gear ratio changing action.

A shifting mechanism pushes linearly the dual mass dog collar to the assigned next free, engageable gear wheel, in order to be engaged with the desired gear wheel that is meant to rotate freely when it is not engaged with the shaft via the dual mass dog collar.

Accordingly the shifting mechanism can linearly pull a dual mass dog collar in order to disengage an engaged gear wheel.

When the engagement means of the dual mass dog collar engage the engagement means of the free, engageable gear wheel of the second gear ratio, the softer spring(s) inside the dual mass dog collar starts to compress and up till the deflection of the outer part of the dual mass dog collar, reaches the second stiffer elastic element, the engagement has been completed.

As the time passes, second elastic element(s) of the dual mass dog collar assigned to the second gear ratio, bear more load and the elastic elements in the dual mass dog collar assigned to the first gear ratio decompress.

When the inner/outer part of the dual mass dog collar assigned to the second gear ratio rotate with the same angular velocity, the gear changing action has been completed and power is transferred via the second gear ratio.

The elastic elements of the dual mass dog collar assigned to the first gear ratio are decompressed and the dual mass dog collar disengages from the engageable gear wheel of the first gear ratio.

When down shifting: The input shaft rotates and power is transferred to the output shaft by means of an initial gear ratio.

After collecting and processing the corresponding data, a gear ratio changing action is commanded from the initial gear ratio to the previous gear ratio after a momentary power cut.

The dual mass dog collar assigned to the second gear ratio is axially moved and thereby the free, engageable gear wheel of the second gear ratio is disengaged.

The free, engageable gear wheel of the previous gear ratio is engaged by the assigned dual mass dog collar and thereby is torque proof engaged with the assigned shaft.

Rotating the input shaft and transferring power to the output shaft by means of the previous gear ratio.

Preferably the first elastic element may be a spring element and the second elastic element can be a rubber element or a resilient element.

Dual mass dog collar (sleeve) can be adopted in manual gearboxes or in automatic gearboxes but a power cut upon gear change action is demanded.

In addition, damping elements can be adopted in the dual mass dog collar, damping the return of the deflected parts, when the dual mass dog collar stops being engaged with a free, engageable gear wheel. The damping elements can be positioned in the inner or outer parts of the dual mass dog collar or by incorporating elastic elements with damping characteristics.

Most power transmission systems for outboard motors or inboard/outboard motors, adapted in boats, are consisted by two output free engageable bevel gears (are free to rotate when not engaged with the shaft, driven gears) assigned to the output shaft and one bevel pinion (drive pinion) assigned to the input shaft engaging both bevel gears.

Bevel pinion is torque proof engaged with a drive shaft (input shaft) that receives power from the engine. Bevel gears are supported by prop shaft (output shaft) which has a marine propeller torque proof engaged with the shaft in one end.

The torque proof connection of the bevel gears to the prop shaft is achieved by a dog clutch (dog clutch collar). The dog clutch collar is positioned in between the bevel gears and is assigned to both bevel gears. The dog clutch collar is torque proof engaged with the assigned shaft but has the ability to be moved axially.

When a gear changing action take place the dog clutch collar disengages from the first bevel gear, which was engaged with, and engages with the second bevel gear. Bevel gears are constantly rotating in an opposite direction in relation to each other. The engagement takes place when the engagement means of the dog clutch enter the engagement means of the bevel gear and when the dog clutch meets the engagement means of the bevel gear, loud grinding noise occurs additionally to the occurring torque peaks. Therefore a short pause is often required, for minimizing the absolute difference in angular velocities of the prop shaft and the second bevel gear which is going to be engaged.

In order to surpass the aforementioned drawbacks of a power transmission system for a marine engine, my innovation proposes the replacement of the dog clutch with a dual mass dog collar (as described above).

As a person skilled in the art understands, due to the fact that the moment of inertia of the outer part of the dual mass dog collar is very small, and as far for the first elastic element a significantly small spring constant (k) is demanded, a quick, smooth, effortless engagement between the engaging components (i.e. dual mass dog collar and free, engageable bevel gear) can be achieved, without damaging the engagement means (e.g. teeth).

In another alternative the axial movement of the dual mass dog collar along the assigned shaft, is guided by helical guiding means so that dual mass dog collar is rotated relative to assigned shaft upon axial movement of the dual mass dog collar.

Depending on the direction of the axial movement of the dual mass dog collar an additional angular velocity, in relation to the shaft's angular velocity, is achieved (either added or reduced).

This provides additional advantages as will be explained in details further on.

The operation of a dual mass dog hub of a dog clutch is exactly analogous to the operation of the dual mass dog collar.

The dual mass dog hub, is torque proof engaged with the shaft and a dog collar assigned on dual mass dog hub is axially moved towards or away the assigned gear wheels, in order to engage or disengage the desired free, engageable gear wheel as will be explained in details further on.

The presented dual mass dog hub is consisted by an inner part and an outer part. The inner part and the outer part are axially fixed to the assigned shaft and the dog collar is axially movable. The inner part is torque proof engaged with the assigned shaft via the engagement means positioned in the inner circumferential surface. The inner part and the outer part have a common rotational axis and are arranged concentrically to the assigned shaft.

Further, the inner part is at least partially arranged within the outer part and the inner part is coupled to the outer part by means of two elastic elements (a first and a second elastic element) with different spring constants in relation to each other, arranged in a parallel configuration, so that the inner part is arranged angularly deflectable with respect to the outer part around the common rotational axis (and vice versa).

The elastic elements can be spring elements, such torque springs or spiral springs, torsional springs, or any other elastic elements such as rubber blocks etc. Further, different types of elastic elements can be combined in a dual mass dog clutch in order to achieve a desired spring characteristic.

The two elastic elements may be positioned within one compartment, formed by the inner part and the outer part of the dual mass dog hub. Alternatively the elastic elements can be positioned in separate compartments but in any case the two elastic elements will be positioned in an arrangement that the first elastic element, having a smaller (in relation to the second elastic element) spring constant, is initially deformed upon deflection of either the inner or the outer part of the dual mass dog hub (providing the required time in order to achieve a complete engagement before the second spring element begins to bear load), and the deformation of the second elastic element (having a greater spring constant in relation to the first spring element) follows as the deflection progresses. In particular, the spring compartment can be a closed compartment. Alternatively, the spring compartment may be an open compartment that allows heat exchange and a facilitated maintenance of the springs.

The at least one dog collar is axially movable along and on top of the assigned dual mass dog hub, with the dog collar being torque proof engaged with the outer part of the dual mass dog hub, and comprises engagement means on at least one of the faces of the dog collar.

The engagement between the at least one dog collar of the dual mass dog clutch and the assigned free, engageable gear wheel is temporally and is achieved with the help of engagement means (e.g. teeth). The engagement means (e.g. teeth) of the at least one dog collar, are adapted to engage with the engagement means of the free, engageable gear wheel.

Upon engagement the at least one dog collar can transfer rotational force and/or torque to the outer part and via the at least two elastic elements to the inner part. Due to the fact that the inner part of the dual mass dog hub is torque proof engaged with the shaft rotational forces and/or torque can be transferred from the free, engageable gear wheel to the shaft and vice versa.

As a person skilled in the art understands, the operation of the dual mass dog hub, is exactly analogous to the operation of the dual mass dog collar as explained with details above. Its without saying that a gearbox may comprise at least one dual mass dog collar or at least one dual mass dog hub or a combination of at least one dual mass dog collar and at least one dual mass dog hub.

### BRIEF DESCRIPTION OF THE FIGURES

In the following, preferred embodiments of the present invention are described with respect to the accompanying figures.

FIG. 1 is a schematic perspective cut view of a dual mass dog collar;

FIG. 2 is a schematic cut view of a gearbox comprising a dual mass dog collar;

FIG. 3 is a schematic cut view of a gearbox comprising a dual mass dog collar;

FIG. 4 gives a schematic illustration of a gearbox comprising two dual mass dog collars;

FIG. 5 gives a schematic illustration of individual components of a an alternative dual mass dog collar;

FIG. 6 gives a schematic illustration of individual components of a an alternative dual mass dog collar;

FIG. 7 is a schematic cut view of a gearbox for a marine engine comprising a dual mass dog collar;

FIG. 8 is a schematic alternative cut view of a gearbox for a marine engine comprising a dual mass dog collar;

FIG. 9 gives a schematic illustration of individual components of a gearbox for a marine engine comprising a dual mass dog collar;

FIG. 10 is an alternative method for securing individual components of a dual mass dog collar;

FIGS. 11A to 11B is an alternative dual mass dog collar comprising helical guiding means and a corresponding helical dog hub;

FIG. 12 is a dual mass dog collar comprising damping elements;

FIG. 13 gives a schematic illustration of individual components of a gearbox for a marine engine comprising a dual mass dog collar and helical guiding means;

FIG. 14 gives a schematic illustration of a gearbox comprising a dual mass dog collar and helical guiding means;

FIG. 15 gives a schematic illustration of a gearbox for an inboard marine engine comprising two dual mass dog collars;

FIG. 16 gives a schematic illustration of individual components of a dual mass dog clutch comprising a dual mass dog hub;

FIGS. 17A to 17E gives a schematic illustration of a gear ratio changing sequence;

### DETAILED DESCRIPTION

As will become apparent from the following, the present application allows to provide a dual mass dog clutch comprising either at least one dual mass dog collar or a dual mass dog hub, for a gearbox, that minimizes the required time for a gear changing action, provides less wear and tear to the engaging components and reduces the emitted noise.

FIG. 1 demonstrates a dual mass dog collar 1 of dog clutch adapted in a gearbox. The dual mass dog collar is consisted by an inner part 40, an outer part 50, elastic elements connecting the inner part 40 and the outer part 50 and engagement means 60 that are adapted to engage a free, engageable gear wheel by interacting with the corresponding engagement means of the free engageable gear wheel.

The inner part 40 and the outer part 50 are angularly deflectable in relation to each other and the deflection is limited by the existence of the elastic elements.

Inner part 40 is provided as torque proof engaged with an assigned shaft by the engagement means 41 provided in the inner circumferential surface of the inner part 40. The engagement means 41 torque proof fix the inner part 40 directly to the shaft (may be torque proof engaged to the shaft via a dog hub which is torque proof engaged to the shaft).

Outer part 50 comprises engagement means 60, adapted to interact with the engagement means of a free, engageable gear wheel.

Upon engagement the otherwise free to rotate gear wheel, is torque proof engaged with the outer part 50.

Since the outer part 50 is connected to the inner part 40 via the elastic elements, the elastic elements will eventually by compressed, up to a point that the rotational forces and or torque from the outer part 50 will be transferred to the inner part 40.

Since the inner part 40 is torque proof engaged with an assigned shaft, by engaging different free, engageable gear wheel different gear ratios can be selected. The selection of different gear ratios is achieved by axially moving the dual mass dog collar along the assigned shaft.

The presented dual mass dog collar is axially moved as an entity, and the axial movement takes place by a corresponding shifting fork movement. The shifting fork is coupled to the outer part by the respective shifting fork coupling 53, positioned on the outer circumferential surface of the outer part 50.

The engagement means 60 are provided in both faces of the outer part 50. Therefore engagement means 60a face one free, engageable gear wheel and engagement means 60b face another. As a result dual mass dog collar 1 can be received in between two free, engageable gear wheels.

The specific shape/form of the engagement means 60 can vary and the presented one is not restrictive. Therefore the engagement means 60 can be protrusions, cavities or a combination of both, with a respective formation in the engagement means of the free, engageable gear wheels.

The number of the engagement means 60 and the number of the engagement means of the free, engageable gear wheels, do not necessarily have to match. The engagement means provided as cavities may be greater in number than the corresponding engagement means provided as protrusions.

As mentioned above, the inner part 40 is coupled to the outer part 50 by means of at least two elastic elements. In the presented section cut only the softer elastic element 70 can be seen but a second elastic element is also provided, with the two elastic elements being concentrically positioned, with the one positioned partially arranged within the other, with the proposed positioning not being restrictive.

Both inner part 40 and outer part 50 comprise elastic element supports, with the inner elastic element supports 42 being visible in the demonstration. Inner elastic element supports 42 are provided as two elastic element supports 42a, 42b with a “gap” in between them in which the outer elastic element support (not visible in this section cut) can be housed.

Finally secure rings 30 are provided, securing the inner part 40 and the outer part 50 in place, with the ability to be angularly deflectable in relation to each other, but axially movable as one.

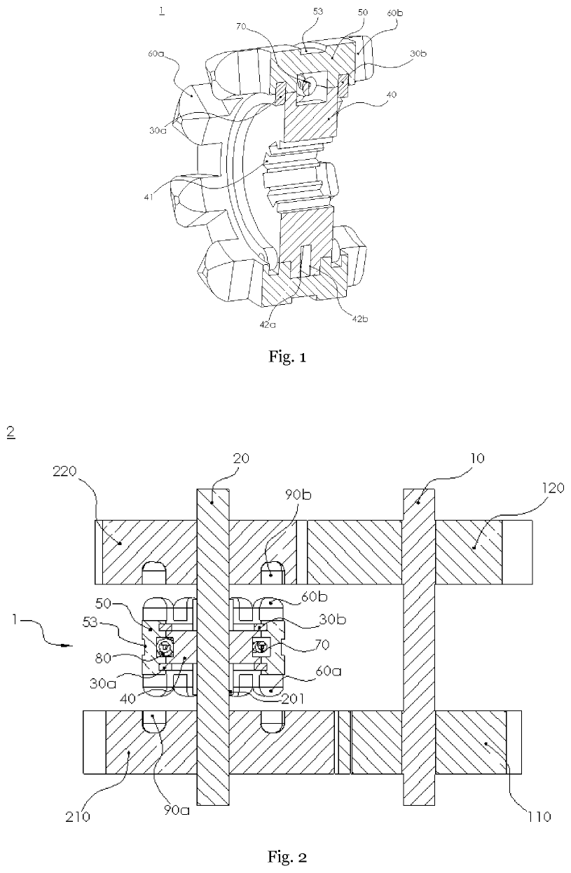

FIG. 2 demonstrates a section cut of a gearbox comprising a dual mass dog collar.

The presented gearbox comprises an input shaft 10, supporting input gear wheels (drive wheels) 110, 120 which are torque proof engaged with the shaft, and an output shaft 20, supporting output gear wheels 210, 220 (driven wheels).

Output gear wheels 210, 220 are provided as free, engageable gear wheel, not transferring torque when being unengaged. The engagement takes place via the provided dual mass dog collar 1 “sandwiched” in between the output gear wheels 210, 220 (in an alternative configuration, shaft 20 and output gear wheels 210, 220 could be drive shaft/gear wheels and shaft 10 and gear wheels 110, 120 could be driven).

The input shaft 10 comprises engagement means 201 adapted to permanently torque proof fix the inner part 40 of the dual mass dog collar 1. Although the inner part 40 is provided as torque proof engaged with the shaft 20, it has the ability to be axially moved, engaging and disengaging the desired output gear wheel 210, 220.

Input gear wheel 110 constantly meshes with output gear wheel 210, and input gear wheel 120 constantly meshes with output gear wheel 220, therefore defining two gear ratios.

As it is obvious the gearbox may comprise more gear ratios with an analogous layout.

The dual mass dog collar adopted in this configuration is the one presented in FIG. 1.

In this section cut the two elastic elements inside the dual mass dog collar 1 can be seen. More specifically the selected exemplary layout comprises two spring elements housed in a single compartment formed by the inner part 40 and the outer part 50, with the two spring elements being positioned the one within the other.

The spring elements, comprise different spring constant in relation to each other. The first spring element 70 has a smaller spring constant in relation to the spring constant of the second elastic element 80. Therefore the first spring element 70 is softer and the second spring element 80 is stiffer.

Finally the engagement means 90 provided on a face of the free, engageable gear wheels can be seen. Since the engagement means 60 are provided as protrusions, the engagement means 90 are provided as cavities, having a corresponding formation matching the formation of the protrusions.

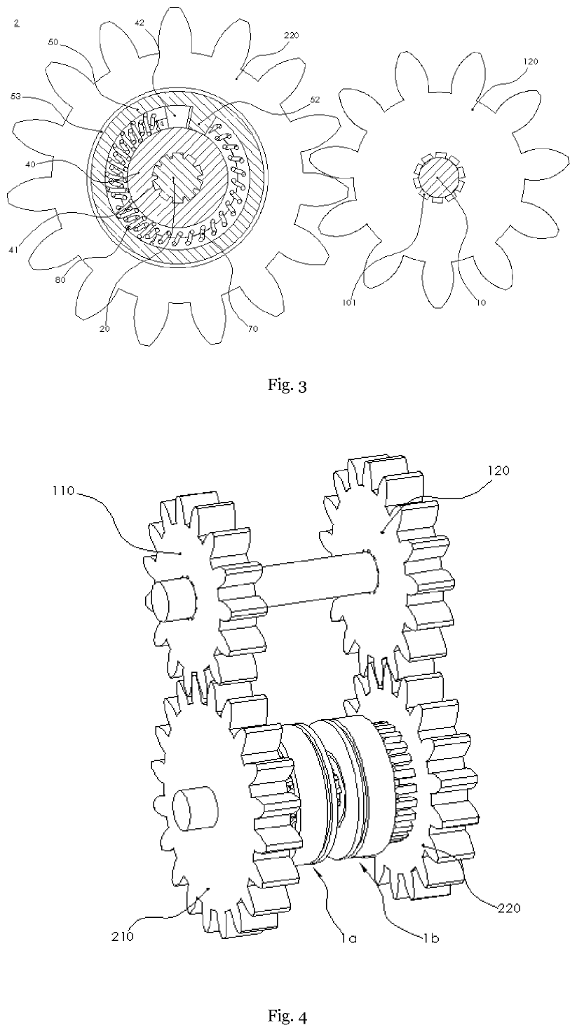

FIG. 3 presents a section cut of the gearbox presented in FIG. 2.

In this section cut, a more clear view of the dual mass dog collar 1 can be seen.

More particularly the specific form of the inner part 40, the outer part 50 and the layout of the elastic elements 70, 80.

Inner part 40 and outer part 50 have a common rotational axis and the inner part 40 is at least partially arranged within the outer part 50.

The first softer spring element 70 is partially arranged within the second elastic element 80 and protrudes out of the second elastic element 80 on a front face. As a result, the first softer spring element 70 is longer than the second elastic element 80.

The first softer spring element 70 is in constant contact with both the inner part 40 and the outer part 50, and is initially deformed upon deflection of either of the inner or the outer part.

The deformation of the second stiffer spring element 80 takes place after the complete engagement of the assigned free, engageable gear wheel, and as the angular deflection of either the inner part 40 or the outer part 50 progresses.

The stiffer spring element 80 is the one that transfers the significant amount of the occurring load and the softer spring element 70 is the one that assists with the engagement, allowing a smooth, complete engagement prior to the load transfer.

Inner elastic element support 42 and outer elastic element support 52 are provided, supporting the elastic elements 70, 80.

As mentioned before, input gear wheels are torque proof fixed gear wheels and as a result input shaft 10 provides engagement means 101, engaging the inner circumferential surface of the input gear wheels and thereby torque proof fix (same angular velocity) said gear wheels to the shaft.

In this demonstration the dual mass dog collar is positioned directly on top of the shaft. It is going without saying that the dual mass dog collar could be positioned on top of a dog hub, with the dog hub being torque proof engaged with the shaft.

FIG. 4 presents an alternative to the gearbox 2, where each free, engageable gear wheel has one dual mass dog collar, assigned to it.

Therefore the free engageable gear wheel 210 has the dual mass dog collar 1a assigned to it and the free engageable gear wheel 220 has the dual mass dog collar 1b assigned to it.

Both dual mass dog collars 1a, 1b, operate as described above in detail but in this configuration can be moved independently in relation to each other. Therefore for example the dual mass dog collar 1a can maintain its axial position while the dual mass dog collar 1b is axially moved.

As it is obvious only the one face of the dual mass dog collar, facing the assigned free, engageable gear wheel, comprises engagement means.

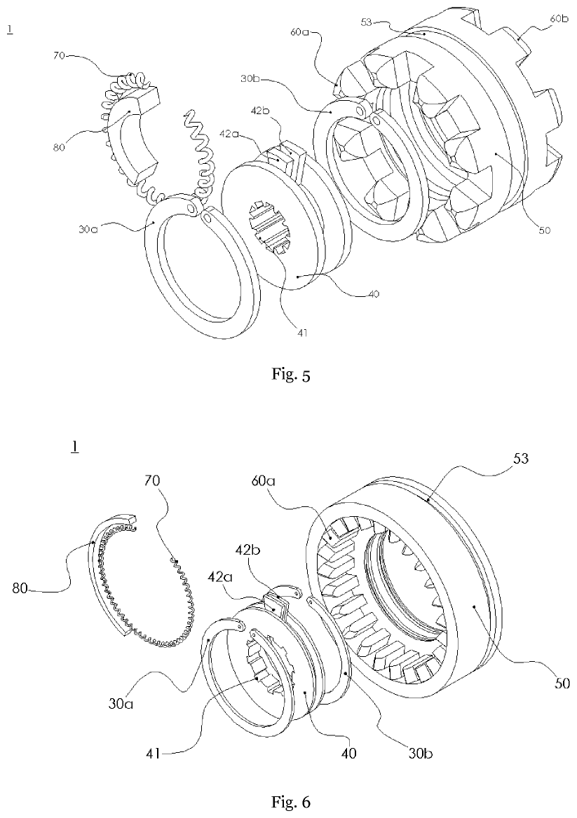

FIG. 5 presents a yet another alternative to the dual mass dog collar 1 presented in FIGS. 1 to 3.

The difference between the previously described configurations is that the elastic elements now comprise a rubber element as a second stiffer elastic element 80. The first softer elastic element 70 is again a spring element and as a result the elastic elements comprise different types of elastic elements (a spring element and a rubber element).

In addition the two elastic elements are not positioned the one within the other but in a position where the first, softer, elastic element 70 is positioned “on top” of the second, stiffer elastic element 80.

FIG. 6 presents a yet another alternative to the dual mass dog collar 1.

In this alternative, the dual mass dog collar 1 comprises engagement means 60 on one face of the outer part 50 and their position is on an inner circumferential surface instead of a front face.

Due to the fact that the engagement means 60 are provided on one face of the outer part 50 and not on both, every free, engageable gear wheel comprises a single dual mass dog collar and there are no free, engageable gear wheels sharing a single dual mass dog collar.

Therefore the movement of each dual mass dog collar can be independent in relation to the movement of the other dual mass dog collars.

In addition in comparison to the alternative presented in FIG. 5, the second stiffer elastic element 80 is positioned on top of the first softer spring element 70.

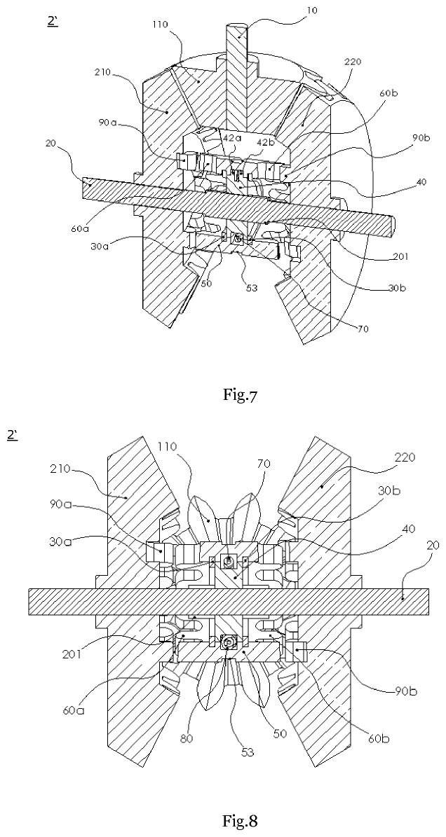

FIG. 7 and FIG. 8 present sectional views of a gearbox 2′ of an outboard or inboard/outboard motor, according to an embodiment of the invention. As can be seen, the gearbox 2′ is consisted by one bevel pinion 110, a first bevel gear 210 and a second bevel gear 220. Both the first and the second bevel gears 210, 220 are constantly meshed with the bevel pinion 110, and the main axis of the bevel gears and the bevel pinions, form a 90° angle.

Bevel pinion 110 is torque proof engaged with a drive shaft 10 that receives power from the engine (drive pinion). Bevel gears 210, 220 are assigned to the prop shaft 20 which has a marine propeller torque proof engaged with the shaft in one end.

Both bevel gears 210, 220 are assigned to the prop shaft 20 but are not constantly torque proof engaged with the prop shaft 20 and therefore are free to rotate when not engaged with the shaft.

The torque proof connection of bevel gears 210, 220 to the prop shaft 20 is achieved by the outer part 50 of the dual mass dog collar which is connected with the inner part 40 of the dual mass dog collar via elastic elements. Dual mass dog collar is positioned in between the bevel gears 210, 220 and is assigned to both bevel gears. The inner part 40 of the dual mass dog collar is torque proof engaged with the assigned shaft but has the ability to be moved axially.

The outer part 50 of the dual mass dog collar has a shifting fork coupling 53 which is coupled to the throttle lever that controls the axial position of the dual mass dog collar. By moving the throttle lever in the according position, dual mass dog collar engages either the first bevel gear 210 or the second bevel gear 220. Additional dual mass dog collar may not interact with any of the divided bevel gears 210, 220 by staying in a neutral position in between the bevel gears 210, 220.

The dual mass dog collar has engagement means 60a, 60b facing each bevel gear 210, 220. As can be seen engagement means 60a are assigned to divided bevel gear 210 which comprises corresponding engagement means goa and engagement means 60b are assigned to the divided bevel gear 220 which comprises corresponding engagement means 90b. In addition, preferably, both the engagement means 90a, 90b of the first and second bevel gears 210, 220 and the engagement means 60a, 60b of the dual mass dog collar, will be consisted by a great number of elements (e.g. teeth). This is preferred due to the fact that a collision between the engagement means 60a, 60b and the front face of the engagement means 90a, 90b of the bevel gears 210, 220 is not desired, and therefore a great number of elements (e.g. teeth) is preferred with each element (e.g. teeth) having a pointed face which facilitates the engagement. When the engagement means 60a, 60b and the engagement means 90a, 90b meet, the significant compression of the softer spring element 70 will begin. In addition the provision of a great number of engagement means, in both the dual mass dog collar and in the bevel gears, decreases the demanded tooth depth of the engagement means.

Therefore it is made clear that the decreased occurred inertia (due to the fact that initially upon engagement, only the outer part 50 of the dual mass dog collar takes part in the engagement/gear selection) accompanied by the existence of the softer spring element 70, result in a quicker and smoother gear change.

Bevel gears 210, 220 have a bevel gear teething on its outer surface which meshes with the bevel pinion teething of the bevel pinion 110.

Inner/outer part of the dual mass dog collar are coupled by two elastic elements where the set is consisted by one spring element 70 that has a smaller spring constant and protrudes on a front face of a second elastic element 80 that has a greater spring constant. In the presented illustration, springs are positioned concentrically in relation to each other with the first spring element protruding out of the second elastic element on a front face, and are housed in a spring compartment formed in between the inner part 40 and outer part 50. As mentioned before each spring consisting the set of springs can be positioned in a separate compartment or can be positioned the one on top of the other. The inner part 40 and the outer part 50 have the ability to deflect angularly in relation to each other up till the set of elastic elements is fully loaded. When the set of elastic elements is fully loaded both the inner part 40 and the outer part 50 rotate with the same angular velocity.

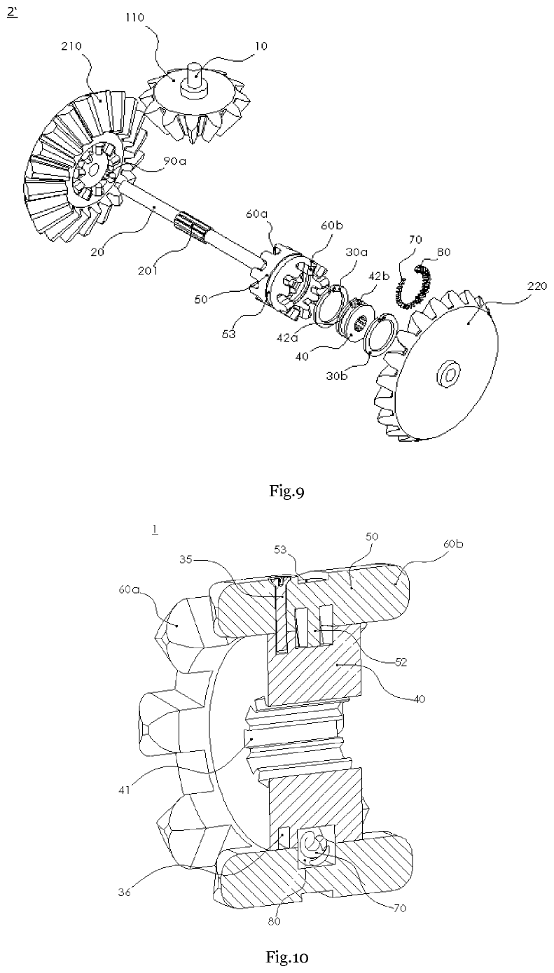

FIG. 9 exemplary demonstrates individual parts of the proposed gearbox of an outboard motor. In this figure a more clear view of the parts consisting the proposed gearbox used in marine engines can be seen.

As mentioned before the dual mass dog collar is torque proof engaged with the prop shaft 20 but has the ability to slide axially depending on the position of the throttle lever, engaging and disengaging the desired gear ratio. The engagement to the shaft takes place with the provision of an engagement surface 41 on the inner cylindrical face of the dual mass dog collar that is in accordance with the engagement means 201 of the prop shaft 20 which extends for a suitable length in relation to the distance of the first and second bevel gears 210, 220.

When the first gear ratio is desired, an according movement of the throttle lever, positions the dual mass dog collar towards the position of the first bevel gear 210. As a consequence the engagement means 60a of the dual mass dog collar interact with the engagement means goa positioned on the front surface of the bevel gear 210, facing the engagement means 60a, and therefore forcing the dual mass dog collar to rotate. Since the dual mass dog collar is torque proof engaged with the prop shaft 20, prop shaft 20 also rotates.

When the outer part 50 of the dual mass dog collar is not engaged with the bevel gear 210 the softer spring of the outer part of dual mass dog collar is considered not to be deformed (the occurring deformation is negligible) and the stiffer spring is also not deformed since is “shorter” in relation to the softer spring and the deflection of the outer part of the divided bevel gear in relation to the inner part is negligible.

When the outer part 50 of the dual mass dog collar begins to engage to the bevel gear 210 by the interaction of the engagement means 60a of the outer part 50, with the engagement means goa of the bevel gear 210, the rotational force is transferred from the outer part to the softer spring element and therefore the deformation of the softer spring element begins, since it was considered not to be deformed. Due to the fact that the softer spring element has a small spring constant and the outer part 50 has small inertia, the engagement takes place smoothly. As it is obvious the softer spring element is deformed initially and after the completion of the engagement, the deformation of the stiffer elastic element follows accompanied by the continuance in deformation of the softer spring element. When the stiffer elastic element begins to bear load in a progressive manner, the substantial amount of power begins to be transferred. When the load is fully borne by the set of elastic elements, both the inner part 40 and the outer part 50 will rotate with the same angular velocities.

FIG. 10 demonstrates an alternative way of securing the inner part 40 and the outer part 50 of the dual mass dog collar 1 when the dual mass dog collar 1 is axially moved as an entity.

In this alternative, the two parts are secured with the help of securing pin 35, which is received in a cavity on the outer circumferential surface. The securing pin 35 may have a spiral first part that is bolted to the outer part 50 and a pin part that secures the inner part 40 in place.

In order to secure the inner part 40 in place, groove 36 is provided, and therefore the inner part 40 although is secured (cannot be independently axially moved in relation to the outer part) can be angularly deflected in relation to the outer part 50 and vice versa.

As it is obvious there are many ways in which the inner part 40 and the outer part 50 can be secured with the two presented not being restrictive.

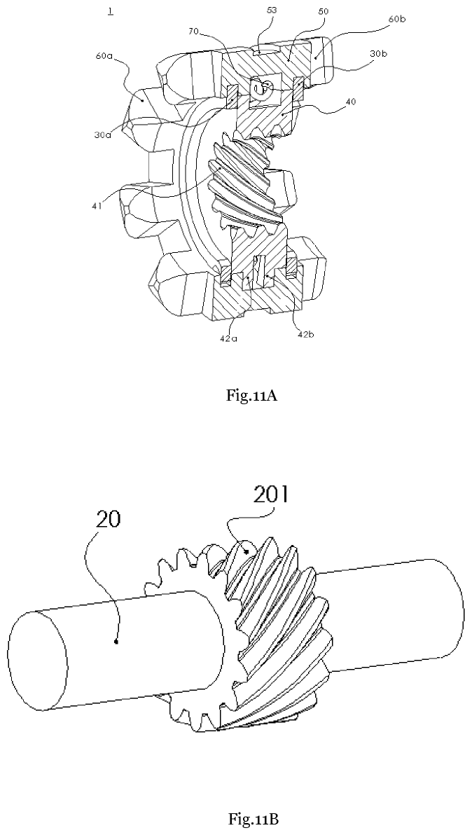

FIG. 11A and FIG. 11B, presents an alternative design where the inner part 40 comprises helical engagement means 41 and is assigned to a dog hub comprising corresponding helical engagement means 201.

In alternative designs, engagement means 41, 201 can comprise a helical groove or protrusion that is adapted to guide the inner part 40 helically i.e. in combined axial and rotational movement.

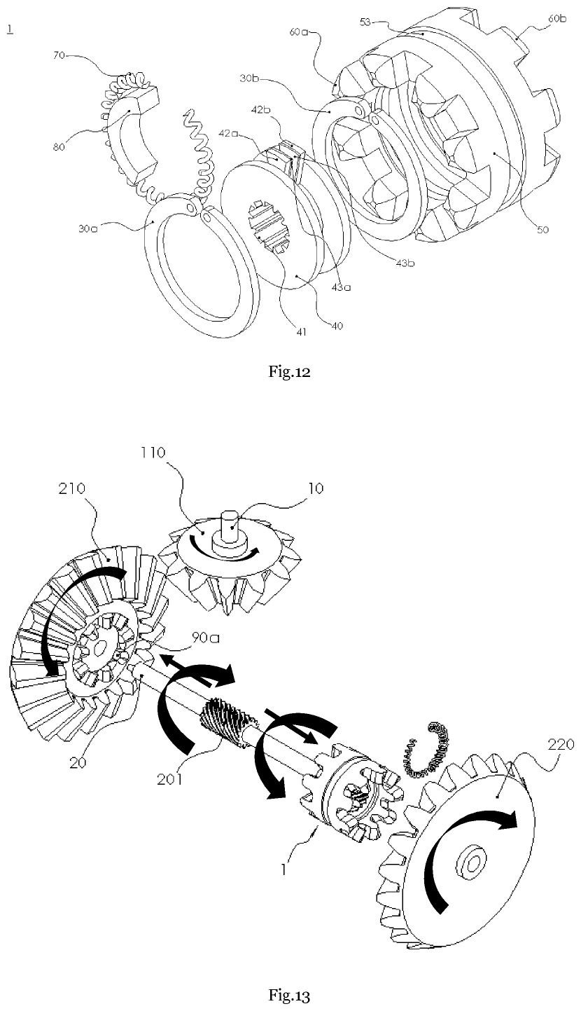

In FIG. 12 an alternative dual mass dog collar 1 is presented.

In this alternative the inner elastic element supports 42 comprise a damping element 43 that damps the return of the outer part 50 when it stops being engaged.

Damping element 43a is on the inner face of the elastic element support 42a and damping element 43b is on the inner face of the elastic element support 42b, facing the damping element 43a. The rest of the individual components are the same as the ones described in the previous layouts.

As it is obvious the position of the damping surfaces is exemplary and many other positions can be selected.

In FIG. 13 a demonstration showing the relative additional angular velocity of the dual mass dog collar can be seen, when helical engagement means 201 are adapted.

More specifically the black curved arrows show the direction of the rotation of the components and the straight arrows show the direction of the axial displacement of the dual mass dog collar 1.

Therefore when the dual mass dog collar 1 is moved towards the bevel gear 210 rotates with an opposite direction of rotation in relation to the direction of rotation of the bevel gear wheel.

At the same time, the softer spring element compresses in the opposite direction, in relation to the direction of rotation of the bevel gear wheel and therefore additional time for the engagement is provided.

When the engagement between the bevel gear 210 and the outer part 50 of the dual mass dog collar initiates, the bevel gear 210 “pulls” the dual mass dog collar 1, assisting and securing the engagement.

The same goes when the dual mass dog collar 1 is moved towards the bevel gear 220.

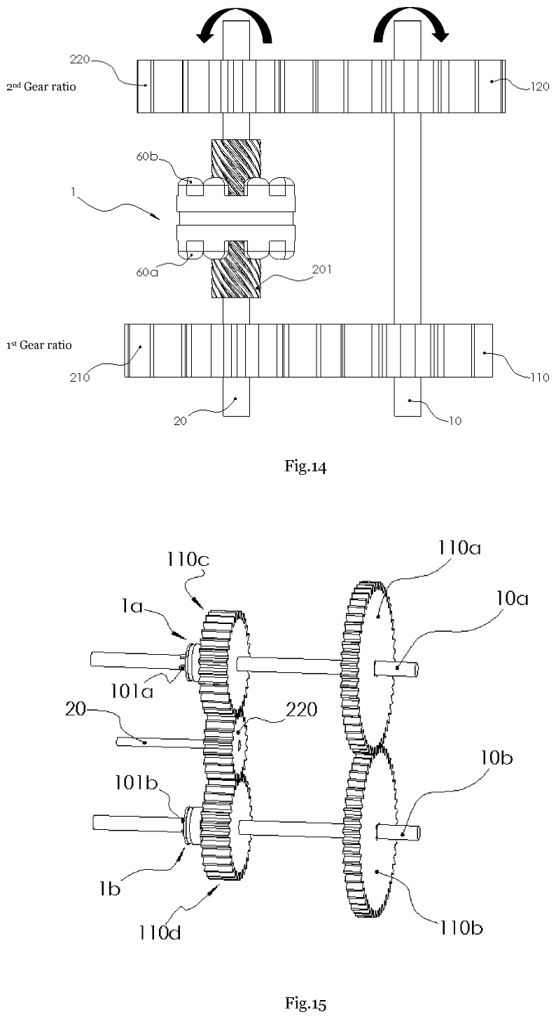

FIG. 14 demonstrates a gearbox which may for example be adopted in an electric vehicle comprising two gear ratios and the engagement means 201, 41 are helically shaped. As mentioned before this helical formation provides additional angular velocity to the dual mass dog collar 1 upon axial movement.

As a result when the dual mass dog collar 1 is axially moved towards the free, engageable gear wheel 220, due to the selected helix angle, it has an additional rotation in the same direction of rotation as the engageable gear wheel 220 (the direction of rotation is given by the arrows on the top part of the figure). As a result the absolute angular velocity of the dual mass dog collar is greater than the absolute angular velocity of the shaft when the gear changing action takes place from a first gear ratio to a second gear ratio.

When the dual mass dog collar 1 is moved towards the engageable gear wheel 210, the absolute angular velocity of the dual mass dog collar is smaller than the absolute angular velocity of the shaft when the gear changing action takes place from a second gear ratio to a first gear ratio.

This feature, assists in smaller differences between the angular velocities of the engaging parts (dual mass dog collar and gear wheel).

It is worth mentioning that when the gearbox operates in a first gear ratio, the gear selecting mechanism should secure the dual mass dog collar in place, due to the fact that the dual mass dog collar wants to be disengaged. In contrast when the second gear ratio is selected the engagement is granted.

FIG. 15 demonstrates a gearbox adopted for example in an inboard marine engine.

The gearbox is consisted by two input shaft 10a and 10b, supporting input gear wheels 110a, 110b which are torque proof engaged with their assigned shafts and constantly mesh.

In addition the input shaft 10a supports the free, engageable gear wheel 110c and the input shaft 10b supports the free, engageable gear wheel 110d.

The free engageable gear wheels 110c, 110d mesh with the output gear wheel 220 which is torque proof engaged with the output shaft 20. At the end of the output shaft 20 a propeller may be torque proof engaged with the shaft.

Dual mass dog collar 1a is assigned to the free engageable gear wheel 110c. The dual mass dog collar 1a is concentrically positioned and torque proof engaged with the input shaft 10a but has the ability to be axially movable in order to engage or disengage the assigned gear wheel 110c.

Similarly the dual mass dog collar 1b is assigned to the free engageable gear wheel 110d.

Therefore by axially moving the desired dual mass dog collar, a gear ratio is selected and the direction of rotation of the output gear wheel 220 (and as a consequence the direction of rotation of the output shaft 20 and the direction of rotation of the propeller) changes.

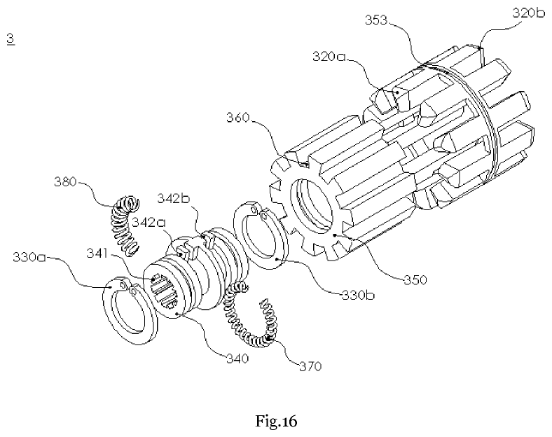

FIG. 16 presents a dual mass dog hub 3. The dual mass dog hub 3 has an analogous operation and a similar layout to the a dual mass dog collar.

In this configuration the hub is provided as a dual mass dog hub and the dog collar is torque proof engaged to the dual mass dog hub and axially moved towards or away the assigned gear wheels, in order to engage or disengage the desired free, engageable gear wheel.

The presented dual mass dog hub (3) comprises an inner part 340, an outer part 350. Therefore the inner part 340 and the outer part 350 are axially fixed to the assigned shaft and the dog collar is axially movable. The inner part 340 is torque proof engaged with the assigned shaft via the engagement means 341 positioned in the inner circumferential surface. The inner part 340 and the outer part 350 have a common rotational axis and are arranged concentrically to the assigned shaft. Further, the inner part 340 is at least partially arranged within the outer part 350 and the inner part 340 is coupled to the outer part 350 by means of two elastic elements 370, 380 (a first and a second elastic element) with different spring constants in relation to each other, arranged in a parallel configuration, so that the inner part 340 is arranged angularly deflectable with respect to the outer part 350 around the common rotational axis (and vice versa).

The elastic elements can be spring elements, such a torque springs or a spiral springs, torsional springs, or any other elastic elements such as rubber blocks etc. Further, different types of elastic elements can be combined in a dual mass dog clutch comprising a dual mass dog hub in order to achieve a desired spring characteristic.

The two elastic elements 370, 380 may be positioned within one elastic element compartment, formed by the inner part 340 and the outer part 350. Alternatively the elastic elements can be positioned in separate compartments but in any case the two elastic elements 370, 380 will be positioned in an arrangement that the first elastic element 370, having a smaller (in relation to the second elastic element 380) spring constant, is initially deformed upon deflection of either the inner or the outer part of the dual mass dog hub (providing the required time in order to achieve a complete engagement before the second spring element 380 begins to bear load), and the deformation of the second elastic element 380 (having a greater spring constant in relation to the first spring element 370) follows as the deflection progresses. In particular, the spring compartment can be a closed compartment. Alternatively, the spring compartment may be an open compartment that allows heat exchange and a facilitated maintenance of the springs.

The dog collar is axially movable along and on top of the assigned dual mass dog hub, with the dog collar being torque proof engaged with the outer part 350 of the dual mass dog hub, and comprises engagement means 320a on one face of the dog collar and engagement means 320b on the opposite face. The torque proof engagement of the dog collar with the outer part 350 takes place with the provision of the engagement means 360 on the outer circumferential surface of the outer part 350, that at the same time torque proof engage and guide the dog collar. The engagement between the dog collar of the dual mass dog clutch 3 and the free, engageable gear wheel is temporally and is achieved with the help of engagement means 320 (e.g. teeth) that are adapted to engage with the engagement means of the free, engageable gear wheel.

Accordingly the dog collar can transfer rotational force and/or torque to the outer part 350 and via the at least two elastic elements 370, 380 to the inner part 340. Due to the fact that the inner part 340 of the dual mass dog hub is torque proof engaged with the shaft rotational forces and/or torque can be transferred from the free, engageable gear wheel to the shaft and vice versa.

In this demonstration, each of the elastic elements 370, 380 is housed in a different compartment.

As can be seen, the first softer spring element 370 is housed in a compartment defined by the inner elastic element support 342a and the second stiffer elastic element 380 in a compartment defined by the inner elastic element support 342b. In addition securing rings 330 secure in axial place the inner part 340 and the outer part 350, and a shifting fork coupling 353 is provided in order to axially move the dog collar.

Again in this alternative the position of the elastic elements is in a parallel configuration and the first softer spring element 370 is the one that is initially deformed.

It is going without saying that the arrangement for housing the spring elements 370, 380 is not restrictive and both can be housed in a single elastic element compartment with the one spring element being received within the other spring element.

In this presentation the dog collar comprises engagement means in both faces. It is going without saying that the engagement means could be comprised only in one face but in that case two dog collars should be adopted, one for each free, engageable gear wheel.

As a person skilled in the art understands, the operation is exactly analogous to the previously described one for the dual mass dog collar 1, with all the mentioned alternative proposals being able to be adapted to the dual mass dog hub.

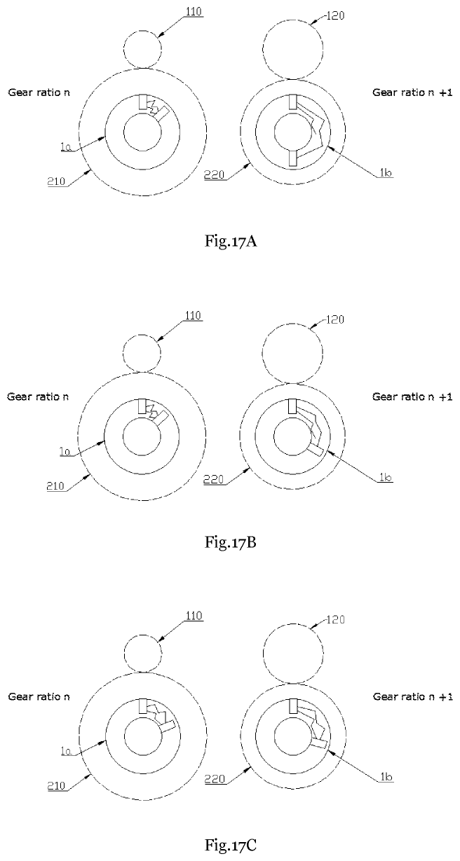

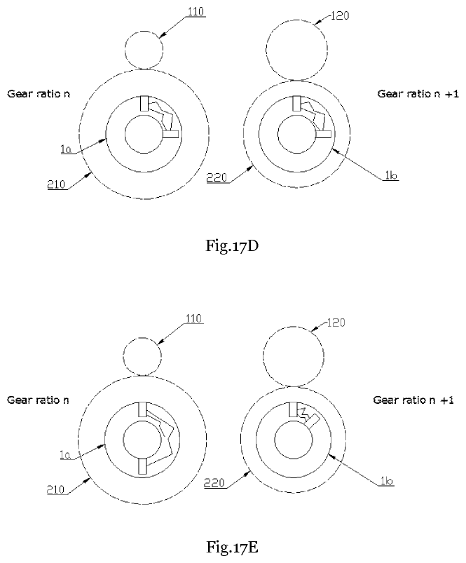

In FIGS. 17A to 17E a schematic illustration of a gear ratio changing sequence is given with the main goal of the illustration being the depiction of the behavior of the elastic elements for a continuously power transfer.

As can be seen gear ratio n is consisted by the torque proof fixed gear wheel 110 which meshes with the free, engageable gear wheel 210 which has the dual mass dog collar 1a assigned to it.

Similarly, gear ratio n+1 is consisted by the torque proof fixed gear wheel 120, which meshes with the free, engageable gear wheel 220 which has the dual mass dog collar 1b assigned to it.

Dual mass dog collars 1a, 1b comprise engagement means only in one face and therefore are able to be moved independently in relation to each other.

In FIG. 17A gear ratio n is selected and 100% of the torque is delivered through gear ratio n. As can be seen both the elastic elements inside the dual mass dog collar 1a are completely compressed and the elastic elements inside the dual mass dog collar 1b are completely decompressed.

In FIG. 17B a command is given in order to engage/disengage the free, engageable gear wheels and upon the beginning of the engagement of gear ratio n+1, the first, softer elastic element begins to compress. Since the first softer elastic elements have a very small spring constant and since the inertia is very small, a smooth easy engagement can be achieved.

In FIG. 17C the second, stiffer elastic element of the dual mass dog collar 1b, begins to compress and as a consequence the second, stiffer elastic element of the dual mass dog collar 1a begins to decompress. For example 0.1% of the occurring torque is delivered through gear ratio n+1 and 99.9% is delivered through gear ratio n.

As time passes and as can be seen in FIG. 17D, more torque is being delivered through gear ration n+1 and less through gear ratio n.

As can be seen as the time passes, the elastic elements of the dual mass dog collar 1b are more compressed and the elastic elements of the dual mass dog collar 1a are less compressed.

For example in FIG. 17D each gear ratio delivers 50% of the torque.

In FIG. 17E 100% of the torque is delivered through gear ratio n+1 and as a consequence the elastic elements of the dual mass dog collar 1b are fully compressed and the elastic elements of the dual mass dog collar 1a are fully decompressed.

From the above it is made clear that during a gear changing action the torque transfer is progressive and there is not a single moment where there is no torque delivery to the output shaft.

As a person skilled in the art understands, the operation is analogous to the previously described one, either when the gearbox comprises a dual mass dog collar or a dual mass dog hub.

The above described gearboxes comprising, allow a quick and smooth engagement when a gear changing action takes place, either by comprising at least one dual mass dog collar or a dual mass dog hub.

As it is obvious all of the described configurations are exemplary and not restrictive and are presented in order to explain and highlight the features of the proposed innovation.

### LIST OF REFERENCE SIGNS

1 dual mass dog collar
2 gearbox
3 dual mass dog clutch
10 input shaft/drive shaft
20 output shaft/prop shaft
30 securing ring
35 securing pin
36 groove
40 inner part
41 engagement means
42 elastic element support
43 damping element
50 outer part
52 elastic element support
53 shifting fork coupling
60 engagement means
70 elastic element/spring element
80 elastic element/spring element
90 engagement means
101 engagement means
110 gear wheel/bevel pinion
120 gear wheel
201 engagement means
210 gear wheel/bevel gear
220 gear wheel/bevel gear
320 engagement means
330 securing ring
340 inner part
342 inner elastic element support
350 outer part
353 shifting fork coupling
360 engagement means
370 elastic element/spring element
380 elastic element/spring element

1. A dual mass dog collar (1), of a dog clutch wherein the dual mass dog collar (1) comprises
an inner part (40) being torque proof engaged with an assigned dog hub or with
an assigned shaft, comprising engagement means (41) on the inner circumferential surface and
an outer part (50) comprising on at least one of its surfaces engagement means (60), adapted for torque transmission to/from an engageable free gear wheel, wherein
the inner part (40) and the outer part (50) have a common rotational axis, wherein
the inner part (40) is at least partially arranged within the outer part (50), wherein
the inner part (40) and the outer part (50) are arranged concentrically to the assigned shaft, wherein
the inner part (40) is arranged angularly deflectable with respect to the outer part (50) around the common rotational axis, wherein
the inner part (40) is coupled to the outer part (50) by means of a first elastic element (70) and a second elastic element (80) wherein
the elastic elements (70, 80) are positioned in a parallel configuration, wherein
Each one of the elastic elements (70, 80) are received within at least one compartment formed by the inner part (40) and the outer part (so), and wherein
the dual mass dog collar (1) is configured axially movable along the assigned dog hub or shaft guided by the provided engagement means (201) of the assigned shaft due to the interaction of the engagement means (201) of the assigned shaft with the corresponding engagement means (41) of the inner part (40).

2. A dual mass dog collar (1) of a dog clutch, according to claim 1, wherein
the spring constant of the first elastic element (70) is lower than the spring constant of the second elastic element (80).

3. A dual mass dog collar (1) of a dog clutch, according to any of claims 1 to 2, wherein
the elastic elements (70, 80) are adapted in a way that the first elastic element (70) is initially deformed upon the angular deflection of inner/outer part and the second elastic element (80) begins to deform after the progression of the deflection of inner/outer part accompanied by a simultaneous and continuing deformation of the first elastic element (70), and wherein
the inner part (40) and the outer part (50) are adapted to rotate with the same angular velocity if the two elastic elements (70, 80) are fully loaded under the occurring load.

4. A dual mass dog collar (1) of a dog clutch, according to any of claims 1 to 3, wherein
the inner and/or the outer parts comprise elastic element supports with dumping elements.

5. A dual mass dog collar (1) of a dog clutch, according to any of claims 1 to 4, wherein
the first and the second elastic elements (70, 80) are spring elements, or wherein
the first elastic element (70) is provided as a spring element and the second elastic element (80) is provided as a rubber element.

6. A dual mass dog collar (1) of a dog clutch, according to any of claims 1 to 5, wherein the inner part (40) is coupled to the outer part (50) by means of additional elastic elements.

7. A dual mass dog hub (3) of a dog clutch, wherein the dual mass dog hub comprises
an inner part (340) comprising engagement means (341) on the inner circumferential surface and being torque proof engaged with an assigned shaft, and
an outer part (350) comprising engagement means (360), adapted for torque transmission to/from at least one dog collar, wherein
the inner part (340) and the outer part (350) have a common rotational axis, wherein
the inner part (340) is at least partially arranged within the outer part (350), wherein
the inner part (340) and the outer part (350) are arranged concentrically to the assigned shaft, wherein
the inner part (340) is arranged angularly deflectable with respect to the outer part (350) around the common rotational axis, wherein
the inner part (340) is coupled to the outer part (350) by means of a first elastic element (370) and a second elastic element (380) wherein
the elastic elements (370, 380) are positioned in a parallel configuration, wherein
Each one of the elastic elements (370, 380) are received within at least one compartment formed by the inner part (340) and the outer part (350) and wherein
the at least one dog collar is configured axially movable along the assigned dual mass dog hub or shaft guided by the provided engagement means (360) of the outer part (350) due to the interaction of the engagement means (360) of the outer part (350) with the corresponding engagement means of the at least one dog collar.

8. A dual mass dog hub (3), according to claim 7, wherein
the spring constant of the first elastic element (370) is lower than the spring constant of the second elastic element (380).

9. A dual mass dog hub (3), according to any of claims 7 to 8, wherein
the elastic elements (370, 380) are adapted in a way that the first elastic element (370) is initially deformed upon deflection of inner/outer part and the second elastic element (380) begins to deform after the progression of the deflection of inner/outer part accompanied by a simultaneous and continuing deformation of the first elastic element (370), and wherein
the inner part (340) and the outer part (350) are adapted to rotate with the same angular velocity if the two elastic elements (370, 380) are fully loaded under the occurring load.

10. A dual mass dog hub (3), according to any of claims 7 to 9, wherein
the inner and/or the outer parts comprise elastic element supports with dumping elements.

11. A dual mass dog hub (3), according to any of claims 7 to 10, wherein
the first and the second elastic elements (370, 380) are spring elements, or wherein the first elastic element (370) is provided as a spring element and the second elastic element (380) is provided as a rubber element.

12. A dual mass dog hub (3), according to any of claims 7 to 11, wherein the inner part (340) is coupled to the outer part (350) by means of additional elastic elements.

13. A gearbox (2), comprising:
an input shaft (10), supporting input gear wheels (110, 120);
an output shaft (20), supporting output gear wheels (210, 220) and
at least one dog clutch comprising at least one dual mass dog collar (1) according to any of claims 1 to 6 and/or at least one dual mass dog hub (3) according to any of claims 7 to 12, wherein
each of the input gear wheels (110, 120) meshes with at least one corresponding output gear wheel (210, 220), thereby defining a gear ratio, and wherein
at least one of the input gear wheels (110, 120) or at least one of the output gear wheels (210, 220) of a gear ratio is an engageable free gear wheel, and may be engaged to the assigned shaft by the assigned at least one dual mass dog collar (1) according to any of claims 1 to 6 and/or the at least one dog collar of the at least one dual mass dog hub (3) according to any of claims 7 to 12.

14. A gearbox (2) according to claim 13, wherein
the input gear wheel (110), is a bevel pinion and the output gear wheels (210, 220) are bevel gears and wherein
the input shaft (10) and the output shaft (20) form a 90° angle.

15. A gearbox (2), according to any of claims 13 to 14, wherein the axial movement of the at least one dual mass dog collar (1) along the assigned shaft (10, 20), or the axial movement of the at least one dog collar of the at least one dual mass dog hub (3) along the assigned at least one dual mass dog hub (3), is guided by helical engagement means (201, 360) so that the dual mass dog collar (1) is rotated relative to assigned shaft (10, 20) upon the axial movement of the dual mass dog collar (1), or the at least one dog collar of the at least one dual mass dog hub (3) is rotated relative to assigned shaft (10, 20) upon the axial movement of the at least one dog collar of the at least one dual mass dog hub (3).

16. The gearbox (2) according to any of claims 13 to 15, further comprising a control unit, position sensors and measuring instruments taking according measurements and providing them to the control unit, wherein the control unit is adapted to command a gear ratio changing action with the provision of respective commands to the at least one dual mass dog collar (1) and/or to the at least one dog collar of the dual mass dog hub (3) after assessing and processing the provided data.

17. A method for operating a gearbox (2) according to any of claims 13 to 16, comprising the following steps:
rotating the input shaft (10) and transferring power to the output shaft (20) by means of an initial gear ratio;
commanding a gear ratio changing action with the provision of respective commands to the at least one dual mass dog collar (1) and/or to the at least one dog collar of the at least one dual mass dog hub (3) after assessing and processing data in a control unit, from the initial gear ratio to a consecutive gear ratio;
axially moving a second dual mass dog collar (1) according to any of claims 1 to 6 and/or a second dog collar of the dual mass dog clutch (3) according to any of claims 7 to 12, towards the engageable free gear wheel of the consecutive gear ratio and thereby engaging the engageable free gear wheel of the consecutive gear ratio, torque proof fixing said gear wheel with the assigned shaft,
axially moving the at least one first dual mass dog collar (1) according to any of claims 1 to 6 and/or the at least one first dog collar of the at least one dual mass dog hub (3) according to any of claims 7 to 12 and thereby disengaging the at least one first dual mass dog collar (1) according to any of claims 1 to 6 or the at least one first dog collar of the at least one dual mass dog hub (3) according to any of claims 7 to 12 from the engageable free gear wheel of the initial gear ratio,
rotating the input shaft and continuously transferring power to the output shaft during the gear changing action, until the entire power is transferred by means of a new gear ratio.

18. The method according to any of claims 13 to 16, wherein the form of the engagement means (201, 360) forces the at least one dual mass dog collar (1) according to any of claims 1 to 6 and/or the at least one dog collar of the at least one dual mass dog clutch (3) according to any of claims 7 to 12 to rotate, when moved axially.

19. An automotive vehicle or a boat comprising at least one dual mass dog collar (1) according to any of claims 1 to 6 and/or at least one dual mass dog clutch (3) according to any of claims 7 to 12 or a gearbox (2) according to any of claims 13 to 16 or a method according to any of claims 17 to 18.
